(19) United States
(12) Patent Application Publication
(10) Pub. No.: US 2014/0279218 A1
(43) Pub. Date: Sep. 18, 2014

(54) SYSTEMS AND METHODS FOR AUTOMATIC FORMATTING AND PURCHASING OF PHOTOS, PRINTS, PERSONALIZED PHOTO PRODUCTS AND AUTOMATED DELIVERY THEREOF

(71) Applicant: POSTALPIX LLC, Brea, CA (US)

(72) Inventor: Isaac LAY, Brea, CA (US)

(73) Assignee: POSTALPIX LLC, Brea, CA (US)

(21) Appl. No.: 14/215,673

(22) Filed: Mar. 17, 2014

Related U.S. Application Data
(60) Provisional application No. 61/802,043, filed on Mar. 15, 2013.

(51) Int. Cl. G06Q 30/06

(52) U.S. Cl. CPC G06Q 30/0633
USPC 705/26.8

(57) ABSTRACT

A photograph ordering platform, comprising a camera configured to acquire a plurality of photographs; a database configured to store the plurality of photographs; photograph ordering application coupled with the database, the photograph ordering application configured to; receive a print or product selection, enable a photograph of the plurality of photographs to be selected, receive a photograph selection, automatically crop the selected photograph based on the selected print or product selection, and transmit the cropped photograph for order fulfillment.

### BACKGROUND

1. Technical Field

The embodiments described herein are related to a photo ordering platform that allows a user to quickly and easily select a photo, select a format, and order prints and other personalized photo products which are then delivered to their house or designated location.

2. Related Art

Conventional photo sites allow users to upload photos, create albums, and order prints, physical albums, or other product offerings. These conventional sites however, typical require or involve laborious uploading and organizing processes. But there is no conventional solution for someone who simply wants to order a print for a photo they capture, e.g., with their cellphone.

### SUMMARY

A platform that allows a user to quickly and easily select a photo, select, format, and purchase a print or other product is described herein.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example mobile platform for quickly and easily ordering prints in accordance with one embodiment;

FIG. 2 are example screen shots that can be displayed by a photo ordering application included in the platform of FIG. 1 in accordance with one embodiment; and

FIG. 3 is a diagram illustrating a processing system on which one or more of the processes described herein may be executed, according to an embodiment

### DETAILED DESCRIPTION

FIG. 1 is a diagram illustrating an example mobile platform 100 for ordering prints in accordance with one embodiment. The mobile platform can be implemented on a mobile communications device such as a cellphone, smartphone, tablet device, etc. As can be seen, the mobile platform 100 comprises a camera 102 that can capture photographs and store the images in a phone database 104. It will be understood that these photographs can be viewed on the mobile communication device.

Platform 100 also comprises a print ordering application 106 that allows the user to select one or more of the photographs stored in database 104 and to order a print therefore. The application can be accessed by clicking on or tapping an icon displayed on the mobile communication device. When the icon is activated, the application will launch and an initial screen 202, such as that illustrated in FIG. 2 will be displayed on the mobile communication device. When the user activates the start button on the screen, then they will be provided with options such as those illustrated in screen 204. The options provide in screen 204 relate to the type of print or product the user desires. For example, the user can select prints, mugs, mouse pads, aluminum plates, cellphone cases, etc.

When the user makes a selection, they can then be shown a screen with options and pricing. For example, if they select prints, they can be shown the formats, such as 4×4, 5×5, 8×8, 2×2 grids, etc. Once the user makes a selection, then application 106 can provide access to the photographs stored in database 104 so that the user can select the photograph or photographs that they want. Once selected, the user may be given the option to manually crop the photo. For example, if the user selected cellphone case, an image of the case with the photograph overlaid can be displayed with an indication of what portion of the photograph will be cropped out. The user can then manually manipulate the image to achieve the desired cropping.

In other instances, the cropping may be automatic, e.g., if the user selects a 4×4 print. In such instances, a cropping function 108 can be called to automatically crop the image as required.

Once the image is ready, the user can select to finish the transaction. The application 106 ca be configured to ask the user to set up an account or log in. Once the user has created an account or logged in, then the order information and cropped image is forwarded to a server 107 that can handle order fulfillment and billing via the radio front end 110 and antenna 111.

Order fulfillment is handled by forwarding the order information to an affiliated print shop that can print the required number of prints in the format requested and mail the prints to the specified address.

During account creation, the user can provide name, address, which can be used during order fulfillment, billing information, such as billing address or credit card number, etc. This information can be stored on the server or in application 106. Moreover, order fulfillment can be handled by application 106 sending the order information directly to the print shop.

A “Love” button can be incorporated into the application 106. Such a button is intended to attract individuals who actually do love the application. Once a user taps this button, they can be requested to write a review of the application. Since only people who actually love the application will tap the button, this will significantly increase the number of reviews received and ensure that most of reviews we receive are positive ones.

Another important feature is the grid print feature. This provides, e.g., a 6×6 inch print that contains 9 quadrants that are 2×2. Each quadrant can contain an individual print. The custom, e.g., iPhone case, which allows someone to select a photo to have printed on the outside of the case is also an important feature.

There are also two gifting options: 1. A virtual gift card that allows someone to pay for gift card in-app and include the recipient emails. The recipient receives a gift card code that they can be redeemed in the application 106; and 2. a Send-to feature that allows a user to save a family members profile on the application or on the server. This profile includes the, e.g., family members name and address. Whenever the customer wants to duplicate or otherwise send the order to the family member, they need only select the family members profile and another package is prepared and sent to the address automatically.

FIG. 3 is a block diagram illustrating an example wired or wireless system 550 that can be used in connection with various embodiments described herein. For example the system 550 can be used as or in conjunction with one or more of the mechanisms or processes described above, and may represent components of application 106, the corresponding server(s), and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A photograph ordering platform, comprising:
a camera configured to acquire a plurality of photographs;
a database configured to store the plurality of photographs;
photograph ordering application coupled with the database, the photograph ordering application configured to;
receive a print or product selection,
enable a photograph of the plurality of photographs to be selected,
receive a photograph selection,
automatically crop the selected photograph based on the selected print or product selection, and
transmit the cropped photograph for order fulfillment.

2. The platform of claim 1, wherein the photograph ordering application is further configured to receive user account information and to transmit user account information with the cropped photograph,

3. The platform of claim 2, wherein the user account information includes a billing address, a mailing address, or both.

4. The platform of claim 2, wherein the photograph ordering application is further configured to enable manual cropping of the photograph depending on the product selected.

5. The platform of claim 1, wherein the print selections include 4×4, 5×5, 8×8, 2×2 grids, or some combination thereof.

6. The platform of claim 1, wherein the products include at least one of an aluminum plate or a cellphone cover.
